(19) United States
(12) Patent Application Publication
(10) Pub. No.: US 2018/0252670 A1
(43) Pub. Date: Sep. 6, 2018

(54) MIXED-POTENTIAL-TYPE SENSOR

(71) Applicants: NGK SPARK PLUG CO., LTD., Nagoya-shi (JP); SPIROSURE, INC., Pleasanton, CA (US)

(72) Inventors: Koji OMORI, Niwa-gun (JP); Masahiro TAKAKURA, Komaki-shi (JP); Solomon SSENYANGE, Fremont, CA (US); Ryan LEARD, Oakland, CA (US)

(73) Assignees: NGK SPARK PLUG CO., LTD., Nagoya-shi (JP); SPIROSURE, INC., Pleasanton, CA (US)

(21) Appl. No.: 15/448,694

(22) Filed: Mar. 3, 2017

(51) Int. Cl. G01N 27/407

(52) U.S. Cl. CPC G01N 27/4077; G01N 27/4074; G01N 27/4075

(57) ABSTRACT

A mixed-potential-type sensor for measuring the concentration of nitrogen oxide contained in a gas under measurement including a solid electrolyte layer having oxygen-ion conductivity, and a pair of porous electrodes formed thereon. One electrode is covered with a first layer containing tungsten oxide as a main component. The other electrode is covered with a gas impermeable second layer. The second layer is in contact with the other electrode without intervention of the tungsten oxide component. The solid electrolyte layer is porous and allows the gas under measurement to permeate from an externally exposed surface of the solid electrolyte layer to the other electrode. The concentration of the nitrogen oxide is detected from a potential difference developed between the electrodes.

### BACKGROUND OF THE INVENTION

### Field of the Invention

The present invention relates to a mixed-potential-type sensor for detecting the concentration of nitrogen oxide (NOx).

### Description of the Related Art

Environmental control, process control, etc., requires measurement of the concentration of NOx contained in a gas under measurement. In particular, diagnosis of asthma requires measurement of NOx contained in exhaled air at a very low concentration (several ppb to several hundreds ppb).

In view of these requirements, a technique has been proposed of connecting, in series, a plurality of sensors each including a reference electrode and a sensor electrode (detection electrode), and forming the senor electrode using WO₃ so as to enhance the selectivity to NOx (see Japanese Kohyo (PCT) Patent Publication No. 2010-519514 (claim 7)). See also U.S. Patent Application Publication No. 2015/0250408, incorporated herein by reference in its entirety.

Since WO₃ eliminates the catalytic activity of the electrode for converting NO₂ to NO, a potential difference is developed between a detection electrode containing WO₃ and a reference electrode containing no WO₃. Thus, the selectivity to NOx is enhanced.

Incidentally, the manufacture of a detection electrode containing WO₃ poses a problem that in a firing step, WO₃ sublimates (scatters) and adheres to the surface of the reference electrode. If WO₃ adheres to the surface of the reference electrode, the reference electrode also loses its catalytic activity. As a result, the potential difference developed between the reference electrode and the detection electrode decreases, and the NOx detection sensitivity of the sensor is lowered. Therefore, sensitivity may vary among the plurality of sensors.

### SUMMARY OF THE INVENTION

In view of the above-described problems, an object of the present invention is to provide a mixed-potential-type sensor which includes a detection electrode containing tungsten oxide, and which prevents deterioration of the sensitivity in detecting nitrogen oxide.

The above object has been achieved by providing, in a first aspect (1), a mixed-potential-type sensor for detecting the concentration of nitrogen oxide contained in a gas under measurement. The mixed-potential-type sensor comprises a solid electrolyte layer having oxygen-ion conductivity; and a pair of porous electrodes formed on the solid electrolyte layer, wherein one of the porous electrodes is covered with a first layer containing tungsten oxide as a main component, the other of the porous electrodes is covered with a gas impermeable second layer, the second layer is in contact with the other of the porous electrodes without intervention of a tungsten oxide component, the solid electrolyte layer is porous and allows the gas under measurement to permeate from an externally exposed surface of the solid electrolyte layer to the other of the porous electrodes, and the concentration of the nitrogen oxide contained in the gas under measurement is detected from a potential difference developed between the porous electrodes.

According to the mixed-potential-type sensor (1), when this sensor is manufactured by firing or the like, the tungsten oxide contained in the first layer diffuses into the one of the porous electrodes, and reaches the interface between the one porous electrode and the solid electrolyte layer. As a result, the one porous electrode loses its catalytic activity for converting NO₂ to NO and functions as a detection electrode.

Meanwhile, even when the tungsten oxide contained in the first layer sublimates due to firing, since the second layer is gas impermeable, the tungsten oxide component cannot reach the interface between the second layer and the other of the porous electrodes, and the tungsten oxide component is not present at the interface. Therefore, the other of the porous electrodes has a catalytic activity for converting NO₂ to NO and functions as a reference electrode.

As described above, the second layer prevents the other of the porous electrodes from losing its catalytic activity as a reference electrode. Therefore, a potential difference is reliably developed between the one of the porous electrodes which serves as a detection electrode and the other of the porous electrodes which serves as a reference electrode. Thus, deterioration of the sensitivity in detecting nitrogen oxide can be prevented.

In a second aspect (2), the above object has been achieved by providing a mixed-potential-type sensor for detecting the concentration of nitrogen oxide contained in a gas under measurement. The mixed-potential-type sensor comprises a solid electrolyte layer having oxygen-ion conductivity; and a pair of porous electrodes formed on the solid electrolyte layer, wherein one of the porous electrodes is covered with a first layer containing tungsten oxide as a main component, the other of the porous electrodes is covered with a second layer which captures a tungsten oxide component originating from the first layer, the solid electrolyte layer is porous and allows the gas under measurement to permeate from an externally exposed surface of the solid electrolyte layer to the other of the porous electrodes, and the concentration of the nitrogen oxide contained in the gas under measurement is detected from a potential difference developed between the porous electrodes.

According to the mixed-potential-type sensor (2), even in the case where the tungsten oxide contained in the first layer sublimates when this sensor is manufactured by firing or the like, the second layer captures the tungsten oxide component originating from the first layer. Therefore, the tungsten oxide component cannot reach the interface between the second layer and the other of the porous electrodes, and the tungsten oxide component is not present at the interface. Therefore, the other of the porous electrodes has a catalytic activity for converting NO₂ to NO and functions as a reference electrode.

As described above, the second layer prevents the other of the porous electrodes from losing its catalytic activity as a reference electrode. Therefore, a potential difference is reliably developed between the one of the porous electrodes which serves as a detection electrode and the other of the porous electrodes which serves as a reference electrode. Thus, deterioration of the sensitivity in detecting nitrogen oxide can be prevented.

In a preferred embodiment (3) of the mixed-potential-type sensor according to the first aspect (1) of the invention, the second layer contains SiO₂ as a main component.

According to the mixed-potential-type sensor (3), the second layer becomes gas impermeable without fail.

In another preferred embodiment (4) of the mixed-potential-type sensor according to the first aspect (1) of the invention, the second layer is formed of molten glass.

According to the mixed-potential-type sensor (4), the second layer becomes gas impermeable without fail.

In a preferred embodiment (5) of the mixed-potential-type sensor according to the second aspect (2) of the invention, the second layer contains SiO₂ as a main component.

According to the mixed-potential-type sensor (5), the second layer becomes gas impermeable without fail.

In another preferred embodiment (6) of the mixed-potential-type sensor according to the second aspect (2) of the invention, the second layer is formed of molten glass.

According to the mixed-potential-type sensor (6), the second layer becomes gas impermeable without fail.

The present invention can provide a mixed-potential-type sensor which includes a detection electrode containing tungsten oxide, and which can prevent deterioration of the sensitivity in detecting nitrogen oxide.

### BRIEF DESCRIPTION OF THE DRAWINGS

FIG. 1 is an exploded perspective view of an NOx sensor apparatus including mixed-potential-type sensors according to an embodiment of the present invention;

FIG. 2 is a bottom view of a sensor unit in which a plurality of mixed-potential-type sensors according to the embodiment of the present invention are connected in series;

FIG. 3 is a sectional view of the sensor unit taken along line A-A of FIG. 2 (sectional view of one of the plurality of serially connected mixed-potential-type sensors shown in FIG. 2);

FIG. 4 is a top view of the sensor unit including a heater;

FIGS. 5A and 5B are photographs showing an image of a cross section of the mixed-potential-type sensor of an example, including an electrode, observed under a scanning electron microscope, and an EPMA (electron probe micro analyzer) image at the same position, respectively; and

FIGS. 6A and 6B are photographs showing an image of a cross section of the mixed-potential-type sensor of a comparative example, including an electrode, observed under a scanning electron microscope, and an EPMA (electron probe micro analyzer) image at the same position, respectively.

### DETAILED DESCRIPTION OF THE PREFERRED EMBODIMENTS

The present invention will now be described in detail with reference to the drawings. However, the present invention should not be construed as being limited thereto.

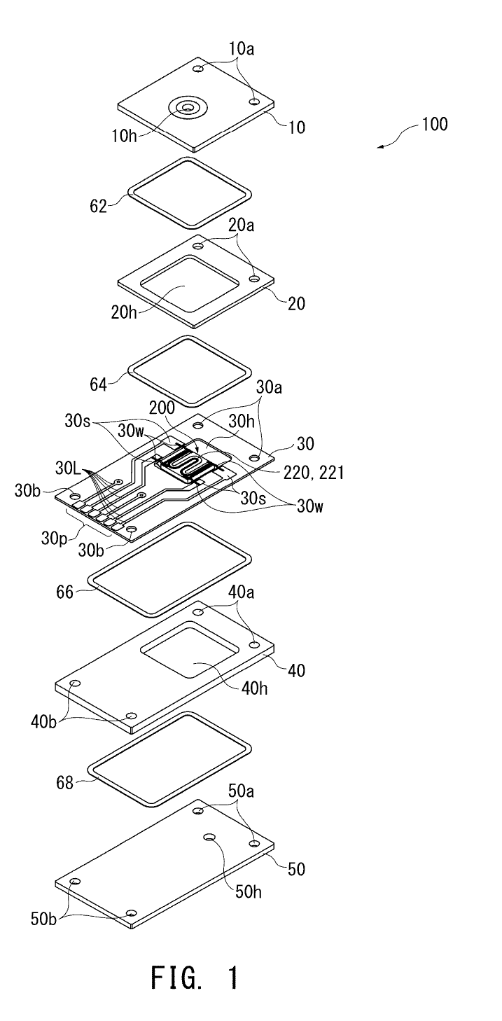

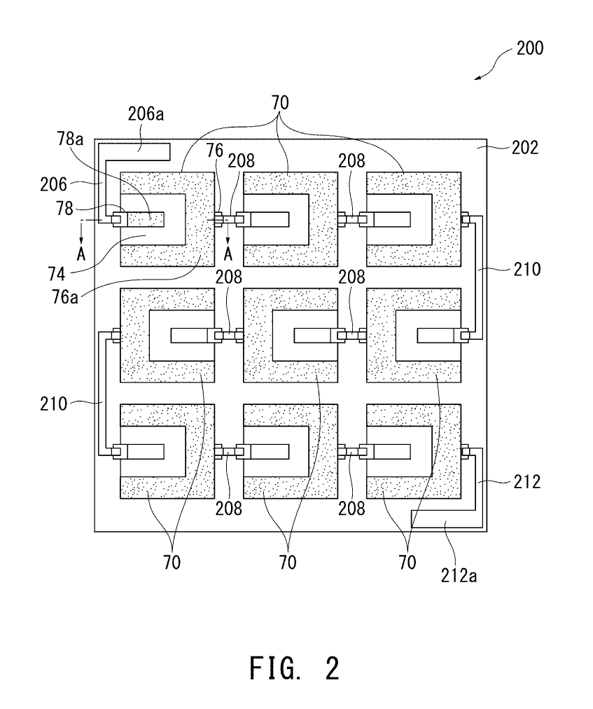

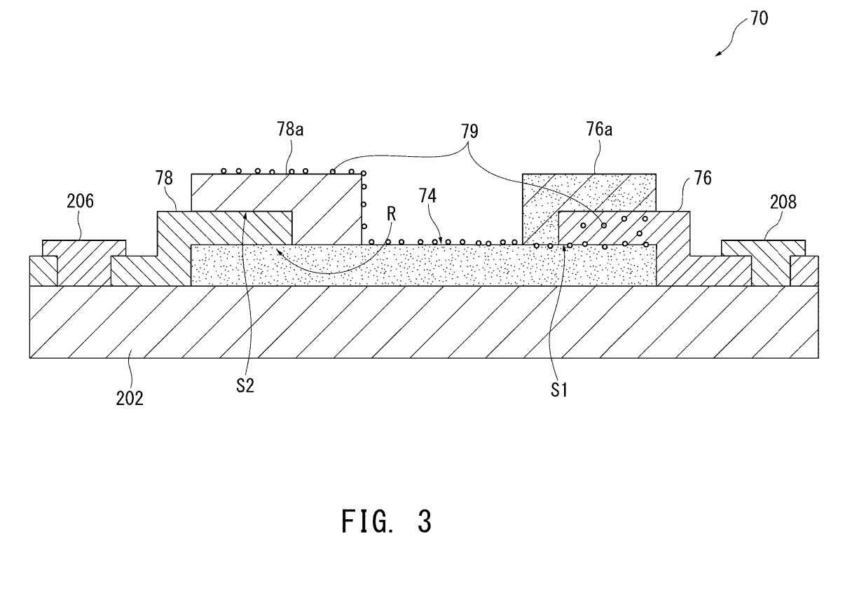

FIG. 1 is an exploded perspective view of an NOx sensor apparatus 100 which includes mixed-potential-type sensors 70 according to an embodiment of the present invention. FIG. 2 is a bottom view of a sensor unit 200 in which the plurality of mixed-potential-type sensors 70 are connected in series. FIG. 3 is a sectional view of the sensor unit 200 taken along line A-A of FIG. 2. Notably, the upper side of FIG. 1 will be referred to as “upper side” and the lower side of FIG. 1 will be referred to as “lower side.”

As shown in FIG. 1, the NOx sensor apparatus 100 includes the sensor unit 200, a ceramic wiring board 30 fixedly suspending the sensor unit 200, a rectangular-frame-shaped first spacer 20 disposed on the upper side of the ceramic wiring board 30, a cover 10 disposed on the upper side of the spacer 20, a rectangular-frame-shaped second spacer 40 disposed on the lower side of the ceramic wiring board 30, and a base 50 disposed on the lower side of the second spacer 40.

The sensor unit 200 has a generally rectangular plate-like shape. A heater 220 and a temperature sensor 221 are disposed on the upper surface of the sensor unit 200. The plurality of mixed-potential-type sensors 70 shown in FIG. 2 are disposed on the lower surface of the sensor unit 200 and are connected in series. The sensor unit 200 measures the concentration of NOx contained in a gas under measurement.

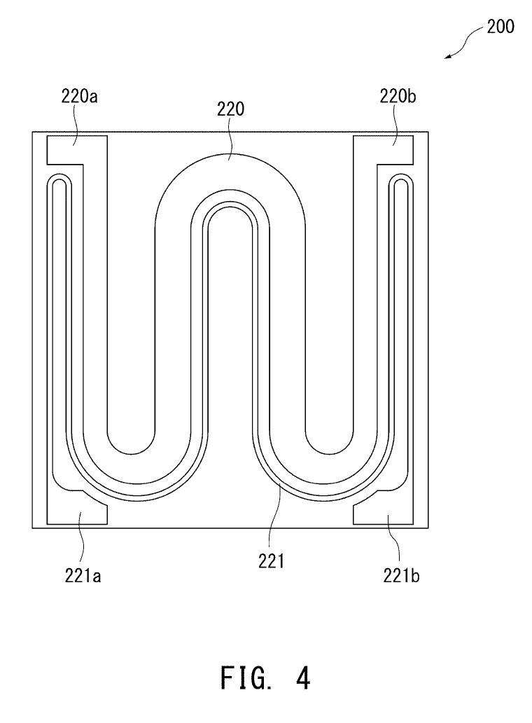

As shown in FIG. 4, conducting pads 220a and 220b are formed on the upper surface of the sensor unit 200 to be located near the upper ends (in FIG. 4) of left-hand and right-hand sides of the sensor unit 200. The conducting pads 220a and 220b form opposite ends of the heater 220 which extends while meandering on the upper surface of the sensor unit 200. The temperature sensor 221 extends while meandering along the heater 220 on the upper surface of the sensor unit 200. Conducting pads 221a and 221b which form opposite ends of the temperature sensor 221 are formed on the upper surface of the sensor unit 200 to be located near the lower ends (in FIG. 4) of the left-hand and right-hand sides of the sensor unit 200.

The ceramic wiring board 30 has an oblong shape and has a rectangular opening 30h on one end side in the longitudinal direction thereof. A plurality of lead traces 30L are formed on front and back surfaces of the ceramic wiring board 30. Inner ends of the lead traces 30L are connected to a plurality of element peripheral pads 30s surrounding the opening 30h, and outer ends of the lead traces 30L are connected to conducting pads 30p on the side opposite the opening 30h in the longitudinal direction.

The sensor unit 200 is accommodated in the opening 30h. Four conducting members 30w extend across the left-hand and right-hand sides of the sensor unit 200 and are joined to the conducting pads 220a, 220b, 221a and 221b on the upper surface side of the sensor unit 200 (on the side where the heater 220 and the temperature sensor 221 are provided) and four element peripheral pads 30s of the ceramic wiring board 30. As a result, the sensor unit 200 is fixedly suspended within the opening 30h of the ceramic wiring board 30.

Meanwhile, as shown in FIG. 2, on the lower surface side of the sensor unit 200 (the side where the mixed-potential-type sensors 70 are provided), end portions 206a and 212a of lead traces 206 and 212 constitute a pair of input/output terminals (electrode pads). Although not illustrated, two element peripheral pads 30s surrounding the opening 30h and the end portions 206a and 212a are joined by conducting members.

Notably, as shown in FIG. 1, on the upper surface side of the sensor unit 200, of the inner ends of the six lead traces 30L, the inner ends of the leftmost lead trace and the fourth lead trace as counted from the left-hand side are not connected to the element peripheral pads 30s on the upper surface of the sensor unit 200. Rather, they are connected to two through holes at a location near the center of the ceramic wiring board 30.

Although not illustrated, on the lower surface side of the sensor unit 200, the outer ends of the lead traces 30L connected to the element peripheral pads 30s on the lower surface of the sensor unit 200 are connected to the above-mentioned lead traces on the upper surface side through the above-mentioned two through holes, and are connected to the leftmost conducting pad 30p and the fourth conducting pad 30p as counted from the left-hand side.

In this manner, electrical signals output from the mixed-potential-type sensors 70 and the temperature sensor 221 are output to the outside through the conducting pads 30p, and the heater 220 is energized for heat generation by electric power externally supplied through the conducting pads 30p.

The first spacer 20 has a square shape and has a rectangular opening 20h which overlaps the opening 30h and is larger than the opening 30h.

The cover 10 has a square shape and has the same dimensions as the first spacer 20. A gas discharge hole 10h is formed in a portion of the cover 10 which faces the opening 20h.

The second spacer 40 has an oblong shape and has the same dimensions as the ceramic wiring board 30. The second spacer 40 has a rectangular opening 40h on the same side as the opening 30h with respect to the longitudinal direction. The opening 40h overlaps the opening 30h and is larger than the opening 30h.

The base 50 has an oblong shape and has the same dimensions as the ceramic wiring board 30. A gas introduction hole 50h is formed in a portion of the base 50 which faces the opening 40h.

The ceramic wiring board 30, the first spacer 20, the cover 10, the second spacer 40, and the base 50 may be formed of a ceramic material such as alumina.

Square seals 64 and 62 are disposed between the ceramic wiring board 30 and the first spacer 20 and between the first spacer 20 and the cover 10, respectively, to surround the opening 20h. Similarly, oblong seals 66 and 68 are disposed between the ceramic wiring board 30 and the second spacer 40 and between the second spacer 40 and the base 50, respectively, to surround the opening 40h. The seals 62 to 68 are formed of glass.

In the present embodiment, the cover 10, the first spacer 20, the ceramic wiring board 30, the second spacer 40, and the base 50 are formed of a ceramic material, and are gastightly bonded and stacked together via the seals 62 to 68 formed of glass-based adhesive layers.

The ceramic wiring board 30 has positioning holes 30a provided at opposite ends of an end portion thereof located on the opening 30h side with respect to the longitudinal direction. Similarly, the ceramic wiring board 30 has positioning holes 30b provided at opposite ends of an end portion thereof located on the conducting pads 30p side.

The first spacer 20 and the cover 10 have positioning holes 20a and 10a, respectively, which are provided at the same positions as the positioning holes 30a.

Similarly, the second spacer 40 has positioning holes 40a and 40b provided at the same positions as the positioning holes 30a and 30b, respectively, and the base 50 has positioning holes 50a and 50b provided at the same positions as the positioning holes 30a and 30b, respectively.

The cover 10, the first spacer 20, the ceramic wiring board 30, the second spacer 40 and the base 50 (these members are also referred to as “the respective members”) are stacked in this order, jigs (guide pins) are passed through the positioning holes 10a to 50a, 40b and 50b to thereby position the respective members, and the respective members are bonded together, whereby the NOx sensor apparatus 100 can be assembled.

The gas under measurement introduced through the gas introduction hole 50h flows through an internal space formed by the opening 40h, comes into contact with the mixed-potential-type sensors 70 of the sensor unit 200, by which the NOx concentration is measured, flows through an internal space formed by the opening 20h, and is discharged to the outside through the gas discharge hole 10h.

Next, the structures of the sensor unit 200 and the mixed-potential-type sensors 70 will be described with reference to FIGS. 2 and 3.

As shown in FIG. 2, the sensor unit 200 includes a generally rectangular plate-shaped base substrate 202. The plurality (9 in FIG. 2) of mixed-potential-type sensors 70 each including a solid electrolyte layer 74 and a pair of electrodes 76 and 78 provided thereon are arrayed at predetermined intervals on the lower surface of the base substrate 202. Notably, the mixed-potential-type sensors 70 are disposed on the lower surface of the base substrate 202 to form a 3×3 matrix; i.e., such that each row extending in the left-right direction of FIG. 2 includes three mixed-potential-type sensors 70 and each column extending in the vertical direction includes three mixed-potential-type sensors 70.

The mixed-potential-type sensors 70 are connected in series by lead traces 206, 208, 210 and 212. Of these traces, the lead traces 206 and 212 have end portions 206a and 212a which serve as a pair of input/output terminals (electrode pads) which are the start and end points of the current path of the series circuit.

The heater 220 (see FIG. 4) provided on the upper surface of the base substrate 202 heats the mixed-potential-type sensors 70 to their operation temperature.

The base substrate 202 may be formed of a ceramic material such as alumina. The heater 220 and the temperature sensor 221 may be formed of a metal such as platinum.

Meanwhile, as shown in FIG. 3, the solid electrolyte layer 74 and the two electrodes 76 and 78 of each mixed-potential-type sensor 70 are provided on the lower surface of the base substrate 202. The solid electrolyte layer 74 has a generally rectangular shape and is formed of a porous solid electrolyte having oxygen-ion conductivity and gas permeability.

The electrode 78 (corresponding to “the other of the porous electrodes” of the invention) which is a porous electrode extends from a position near one side of the solid electrolyte layer 74 toward the outside of the solid electrolyte layer 74 while contacting the surface of the solid electrolyte layer 74, and is in contact with the lower surface of the base substrate 202. The externally exposed surface of a portion of the electrode 78, which portion is in contact with the solid electrolyte layer 74, is covered with a gas impermeable second layer 78a.

The electrode 76 (corresponding to “one of the porous electrodes” of the invention) which is a porous electrode extends from a position near the opposite side the solid electrolyte layer 74 (the side opposite to the electrode 78) toward the outside of the solid electrolyte layer 74 while contacting the surface of the solid electrolyte layer 74, and is in contact with the lower surface of the base substrate 202. The externally exposed surface of a portion of the electrode 76, which portion is in contact with the solid electrolyte layer 74, is covered with a first layer 76a which contains tungsten oxide (WO₃) as a main component (in an amount greater than 50 mass %). Notably, as shown in FIG. 2, the electrode 76 is formed along three sides of the solid electrolyte layer 74, other than the side adjoining to the electrode 78, so as to form a U-like shape to thereby surround the electrode 78. The solid electrolyte layer 74 is exposed to the outside in a region between the electrode 78 and the electrode 76.

The lead traces 206 and 208 are electrically connected to portions of the electrodes 76 and 78, respectively, which portions are in contact with the lower surface of the base substrate 202.

The electrodes 76 and 78 may contain, for example, Pt as a main component (in an amount greater than 50 mass %). The second layer 78a may contain molten SiO₂ as a main component (in an amount greater than 50 mass %) or may be formed of molten glass.

Each mixed-potential-type sensor 70 is formed by applying paste materials for forming the solid electrolyte layer 74, the electrodes 76 and 78, the first layer 76a, and the second layer 78a onto the base substrate 202 by, for example, printing, followed by firing. As shown in FIG. 3, as a result of the firing, a tungsten oxide component 79 originating from the first layer 76a diffuses into the electrode 76 and reaches (exists at) the interface S1 between the electrode 76 and the solid electrolyte layer 74. As a result, the electrode 76 loses its catalytic activity for converting NO₂ to NO and functions as a detection electrode for conveying NO₂ to the interface S1.

Meanwhile, as a result of the firing, the tungsten oxide component 79 within the first layer 76a sublimates (scatters). However, in the mixed-potential-type sensor 70 of the present embodiment, on account of providing the gas impermeable second layer 78a, the tungsten oxide component 79 cannot reach the interface S2 between the second layer 78a and the electrode 78, and the tungsten oxide component 79 is not present at the interface S2. The tungsten oxide component 79 originating from the first layer 76a is captured by the second layer 78a and is prevented from reaching the interface S2 between the second layer 78a and the electrode 78. As a result, the electrode 78 has a catalytic activity for converting NO₂ to NO at a ratio corresponding to the temperature and functions as a reference electrode.

As described above, the second layer 78a prevents the reference electrode 78 from losing its catalytic activity. Therefore, a potential difference is reliably developed between the detection electrode 76 which has no catalytic activity and conveys NO₂ to the interface S1 and the reference electrode 78 which converts NO₂ to NO. Thus, deterioration of the sensitivity in detecting NOx (nitrogen oxide) can be prevented.

Notably, since the electrode 78 is covered with the gas impermeable second layer 78a, it becomes difficult to introduce the gas under measurement from the surface of the electrode 78. In view of this, the solid electrolyte layer 74 is formed of a gas permeable porous solid electrolyte. Therefore, as shown in FIG. 3, the gas under measurement can flow along a route R which extends from the externally exposed surface of the solid electrolyte layer 74 to the electrode 78 through the solid electrolyte layer 74, and reach the electrode 78.

Notably, the fact that the solid electrolyte layer 74 and the electrodes 76 and 78 are porous can be confirmed by checking whether or not pores are preset in a secondary-electron image of a cross section of the layer and the electrodes.

The present invention is not limited to the above-described embodiment and encompasses various modifications and equivalents falling within the scope of the invention.

For example, the shapes of the solid electrolyte layer, the shape of the porous electrodes, the shape of the mixed-potential-type sensor, etc., are not limited to those of the above-described embodiment.

### EXAMPLE 1

A mixed-potential-type sensor having the structure shown in FIG. 3 was manufactured as follows.

First, a green base substrate 202 of alumina was formed by a doctor blade method. A Pt paste was screen-printed on one side of the green base substrate 202 to thereby form the heater 220 and the temperature sensor 221. After that, the entirety was heated at 400° C. for 4 hours for debindering and fired at 1,350° C. for 2 hours.

A YSZ (the addition amount of Y to ZrO₂: 8 mol %) paste was screen-printed on the opposite side of the fired base substrate 202, and firing was carried out at 1,350° C. for 3 hours in a nitrogen atmosphere to thereby form the solid electrolyte layer 74. In this firing, sintering of YSZ was not allowed to progress sufficiently, so that the solid electrolyte layer 74 became porous. Another method for making the solid electrolyte layer 74 porous is to add glass particles or the like to the YSZ paste which foam at that firing temperature.

Subsequently, a Pt paste was screen-printed on the surface of the solid electrolyte layer 74, and firing was carried out at 850° C. for 10 minutes so as to form the electrodes 76 and 78. Notably, in order to improve adhesion to the first layer 76a, glass particles may be added to the Pt paste for the electrode 76.

Next, a paste containing zeolite as a main component was screen-printed on the surface of the electrode 78, and firing was carried out at 950° C. for 2 hours so as to form the second layer 78a. Subsequently, a tungsten oxide paste was screen-printed on the surface of the electrode 76, and firing was carried out at 750° C. for 1 hour so as to form the first layer 76a. As a result, the mixed-potential-type sensor 70 of the example was completed. Notably, since the second layer 78a was formed by firing the paste containing zeolite as a main component at 950° C. for 2 hours, the second layer 78a was formed as a gas impermeable layer of dense molten glass.

As a comparative example, a mixed-potential-type sensor was manufactured in the same manner except that the second layer 78a was formed by firing zeolite at 875° C. for 1 hour.

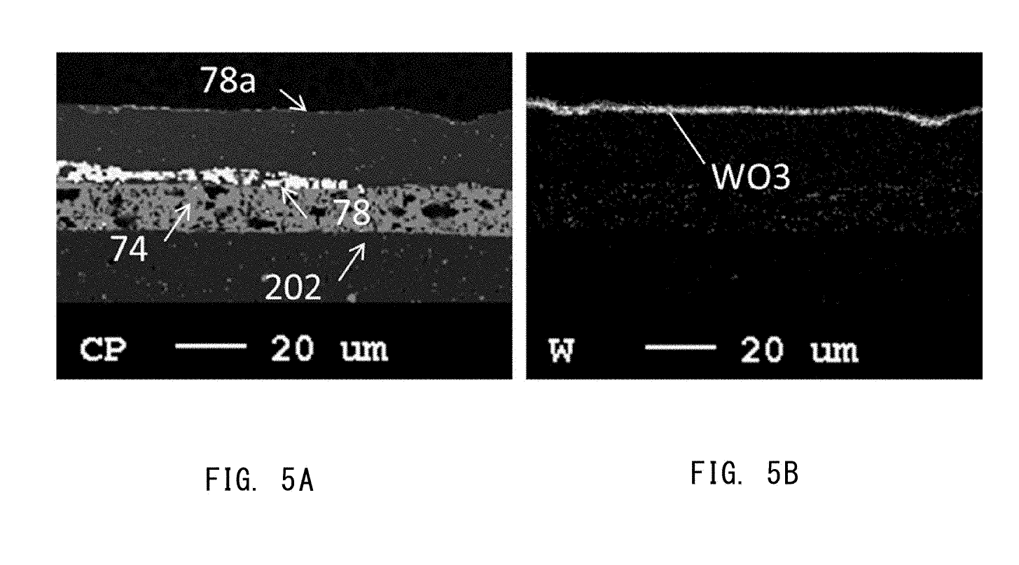

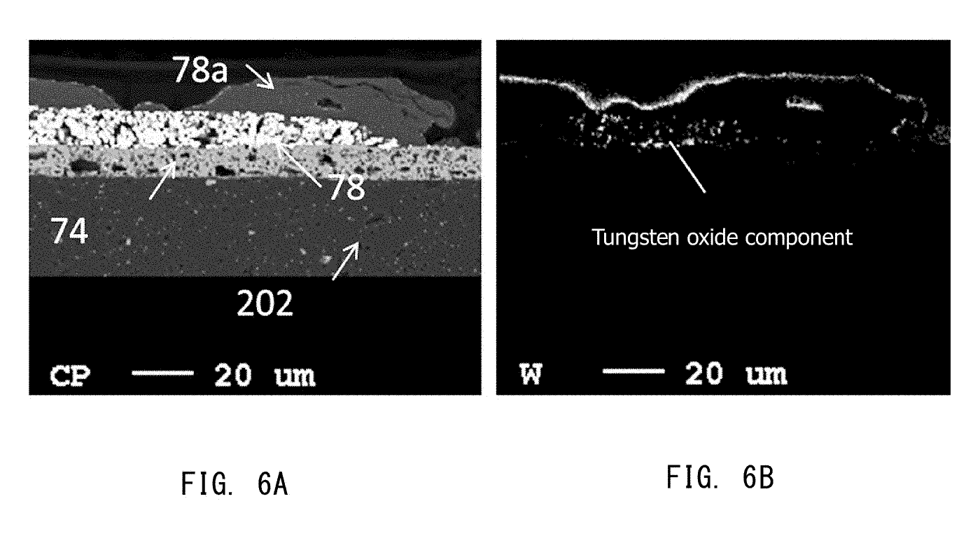

FIGS. 5A and 5B show an image of a cross section of the mixed-potential-type sensor of the example, including the electrode 78, observed under a scanning electron microscope, and an EPMA (electron probe micro analyzer) image at the same position, respectively. FIGS. 6A and 6B show an image of a cross section of the mixed-potential-type sensor of the comparative example, including the electrode 78, observed under a scanning electron microscope, and an EPMA (electron probe micro analyzer) image at the same position, respectively.

In the case of the mixed-potential-type sensor of the example, as shown in FIG. 5B, the tungsten oxide component exists only on the surface of the second layer 78a and cannot reach the interface S2 between the second layer 78a and the electrode 78.

In contrast, in the case of the mixed-potential-type sensor of the comparative example, as shown in FIG. 6B, the tungsten oxide component reaches the interface S2 between the second layer 78a and the electrode 78.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

What is claimed is:

1. A mixed-potential-type sensor for detecting the concentration of nitrogen oxide contained in a gas under measurement, comprising:
a solid electrolyte layer having oxygen-ion conductivity; and
a pair of porous electrodes formed on the solid electrolyte layer, wherein
one of the porous electrodes is covered with a first layer containing tungsten oxide as a main component,
the other of the porous electrodes is covered with a gas impermeable second layer,
the second layer is in contact with the other of the porous electrodes without intervention of a tungsten oxide component,
the solid electrolyte layer is porous and allows the gas under measurement to permeate from an externally exposed surface of the solid electrolyte layer to the other of the porous electrodes, and
the concentration of the nitrogen oxide contained in the gas under measurement is detected from a potential difference developed between the porous electrodes.

2. A mixed-potential-type sensor for detecting the concentration of nitrogen oxide contained in a gas under measurement, comprising:
a solid electrolyte layer having oxygen-ion conductivity; and
a pair of porous electrodes formed on the solid electrolyte layer, wherein
one of the porous electrodes is covered with a first layer containing tungsten oxide as a main component,
the other of the porous electrodes is covered with a second layer which captures a tungsten oxide component originating from the first layer,
the solid electrolyte layer is porous and allows the gas under measurement to permeate from an externally exposed surface of the solid electrolyte layer to the other of the porous electrodes, and
the concentration of the nitrogen oxide contained in the gas under measurement is detected from a potential difference developed between the porous electrodes.

3. The mixed-potential-type sensor as claimed in claim 1, wherein the second layer contains SiO₂ as a main component.

4. The mixed-potential-type sensor as claimed in claim 1, wherein the second layer is formed of molten glass.

5. The mixed-potential-type sensor as claimed in claim 2, wherein the second layer contains SiO₂ as a main component.

6. The mixed-potential-type sensor as claimed in claim 2, wherein the second layer is formed of molten glass.
